(19) United States
(12) Patent Application Publication
(10) Pub. No.: US 2024/0233526 A1
(43) Pub. Date: Jul. 11, 2024

(54) DYNAMIC CONTROL OF INFRASTRUCTURE FOR VULNERABLE USERS

(71) Applicant: Intel Corporation, Santa Clara, CA (US)

(72) Inventors: Frederik Pasch, Karlsruhe (DE); Fabian Oboril, Karlsruhe (DE); Cornelius Buerkle, Karlsruhe (DE); Satish Chandra Jha, Portland, OR (US); Vesh Raj Sharma Banjade, Portland, OR (US); Kathiravetpillai Sivanesan, Portland, OR (US); Arvind Merwaday, Beaverton, OR (US); S M Iftekharul Alam, Hillsboro, OR (US); Ned M. Smith, Beaverton, OR (US); Kuilin Clark Chen, Portland, OR (US); Leanardo Gomes Baltar, Muenchen (DE); Suman A. Sehra, Folsom, CA (US); Soo Jin Tan, Shanghai (CN); Markus Dominik Mueck, Unterhaching (DE)

(21) Appl. No.: 18/572,038

(22) PCT Filed: Sep. 24, 2021
(86) PCT No.: PCT/CN2021/120206

§ 371 Date: Dec. 19, 2023

(51) Int. Cl. G08G 1/07; G06V 20/54; G06V 40/20; G08G 1/005; G08G 1/16

(52) U.S. Cl. CPC G08G 1/07; G06V 20/54; G06V 40/25; G08G 1/005; G08G 1/166

(57) ABSTRACT

Systems and methods for dynamically controlling an infrastructure item are disclosed. The systems and methods may include receiving environmental data. The environmental data may capture behavior of a crossing user. An intent of the crossing user may be determined based on the environmental data. A setting of the infrastructure item may be changed based on the intent of the crossing user.

### FIELD OF THE DISCLOSURE

The present subject matter relates to dynamically controlling an infrastructure item. Specifically, the present disclosure relates to dynamically controlling an infrastructure item to improve safety of vulnerable crossing users and improve traffic flow proximate a crossing.

### BACKGROUND

Autonomous vehicle usage is a fast growing area of technology.

Currently, autonomous vehicles exist in various stages of automation. The automation ranges from a person being required to perform every action to drive the car, to fully autonomous where the vehicle is able to navigate from point A to point B without any human intervention. As automation increases, increasing need to control traffic signals to protect vulnerable road users may become more prevalent.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a system in accordance with at least one example of this disclosure.

FIG. 2 shows a heatmap in accordance with at least one example of this disclosure.

FIG. 3 shows a panel in accordance with at least one example of this disclosure.

FIG. 4 shows a method in accordance with at least one example of this disclosure.

FIGS. 5A and 5B each shows an example use case scenarios showing negotiation and coordination for informed and interactive VRU crossing in accordance with at least one example of this disclosure.

FIG. 6 shows a method in accordance with at least one example of this disclosure.

FIG. 7 shows a block diagram illustrating an example machine upon which any one or more of the techniques (e.g., methodologies) discussed herein may perform in accordance with at least one example of this disclosure.

### DETAILED DESCRIPTION

In urban areas, traffic lights may play an important role in protecting pedestrians from accidents involving vehicles. Traffic lights are typically optimized for the vehicle traffic. For example, by using induction loops in the pavement to register waiting vehicles, traffic lights can change from red to green to allow traffic to flow without undue delay. Pedestrians, people riding bicycles scooters, etc. (referred to herein as vulnerable road users (VRUs)) often have to request a green light by pushing a button. As disclosed herein, red, yellow, and green lights may be referred to as red phase, yellow phase, and green phase.

To encourage people to walk, cycle, use e-scooters, etc., VRUs may receive a higher priority at traffic lights. This may be achieved by remodeling urban areas. For example, by reducing the available vehicle lanes and increasing pedestrian/bike lanes, people may be encouraged to walk and/or cycle. Optimization of traffic lights' green phases as disclosed herein may also be used to give priority to VRUs.

For vehicles, there have long been detection loops that are installed in the pavement. For VRUs there currently are no solutions that allow VRUs to be priorities while at the same time providing smooth and orderly flow of traffic when VRUs are not present.

As disclosed herein, an infrastructure-based monitoring system may be used to detect and predict the behavior and/or intent of VRUs in order to optimize the green phases of traffic lights at intersections. For example, by using a multi-modal sensor setup such as cameras, LiDAR, radio proximity estimation, etc. data can be collected from VRUs and a behavior may be predicted and/or an intent inferred in order to optimize green phases of traffic lights at intersections. By detecting an amount of VRUs that plan to cross a street at a signalized crossing, the priority towards other road users may be dynamically adapted. The optimized traffic flow may increase the acceptance for traffic lights (i.e., they turn “green” whenever there is a need to) and therefore also increase the safety as less VRUs will disobey the regulations (e.g., cross during a red phase) because of shorter wait times.

As disclosed herein, sensors and other elements of infrastructure may allow for the collection of data related to VRUs behavior with respect to traffic intersections. The data may be used as part of a machine learning framework to allow prediction and/or intent models to be created and trained. Using the models, VRU behavior may be predicted based on an intent of a VRU. The behavior may allow traffic lights or other infrastructure to be controlled to reduce congestions, minimize potential accidents with vehicles involving VRUs, etc. The systems and methods disclosed herein may allow for dynamic time intervals between the various phases for traffic lights.

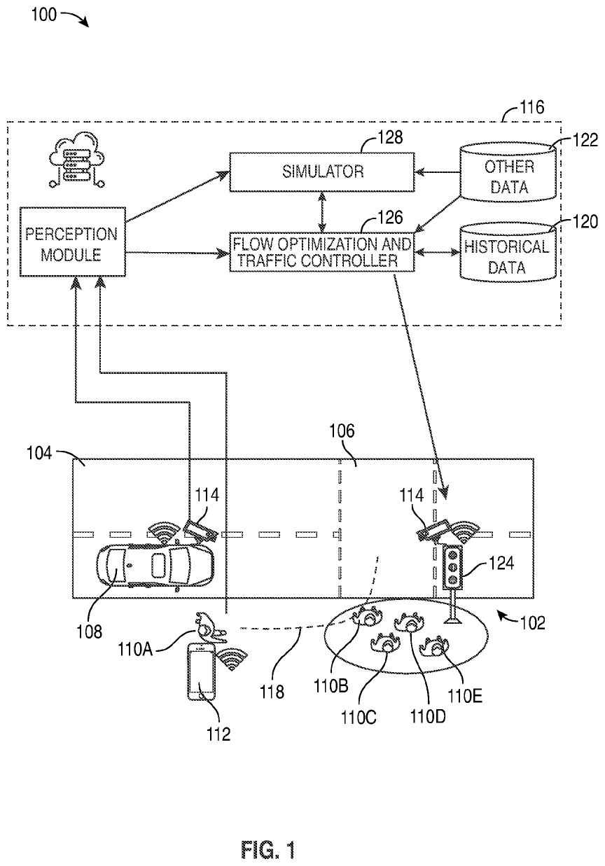

Turning now to the figures, FIG. 1 shows a system 100 for dynamically controlling infrastructure in accordance with at least one example of this disclosure. As shown in FIG. 1, system 100 may include an infrastructure item 102 located proximate a roadway 104 having a crossing 106. During use, a vehicle 108 may travel along roadway 104. Crossing users 110 (labeled individually as crossing user 110A, 110B, . . . 110E) can cross roadway 104 at crossing 106. Each of crossing users 110 may carry a mobile device and/or wear a smart watch, represented as a mobile device 112. As disclosed herein, infrastructure item 102, vehicle 108, and/or mobile device 112 may include sensors and/or communication capabilities (e.g., cellular, Bluetooth, WIFI communications, etc.) that allow them to communicate with one another and/or with an edge or cloud computing environment 116. As disclosed herein, an infrastructure item may include, but is not limited to, any cellular access equipment providing vehicular services (e.g., Multi-access Edge Compute or Mobile Edge Compute) stations, macro/micro/pico/femto base stations, cloud services being connected to cellular services to users, any item deployed close to a road including a cellular and/or direct link vehicular communications component (e.g., a vehicular communications component physically attached to a traffic light, etc.), etc.

As disclosed herein, system 100 may allow for a multi-modal perception using the sensors from infrastructure item 102, vehicle 108, and mobile device 112 to detect VRUs and to predict a behavior and/or determine an intent of crossing user 110 (sometimes referred to as a VRU). The various sensors may include cameras, LiDAR, etc. that may provide data to a perception module 115 that may be used to identify, locate, and track crossing users 110. Additional detection methods may be used to predict a behavior and/or intent of crossing users 110. For example, cameras 114 may be used to detect and track crossing users 110. Cameras 114 may also capture images of crossing users' 110 faces, which in turn may be used to determine the direction in which crossing users 110 are looking. By knowing the direction in which each of crossing users 110 is looking, a prediction may be made and/or an intent may be determined as to whether crossing users 110 plans to cross roadway 104 at crossing 106. Using object tracking, preplanned route data, etc. a trajectory of the crossing users 110 may be determined to aid in improving behavior and intent determinations as disclosed herein.

The environmental data received captured by the sensors can be transmitted to and received by computing environment 116 to predict behavior of both crossing users 110 and vehicles operated upon roadway 104, such a vehicle 108. As disclosed herein, the crossing intent of crossing users 110, which may be pedestrians, cyclist, scooter riders, etc., may be estimated in multiple phases. A first phase may include a period when crossing users 110 are approaching crossing 106. A second phase may include when crossing users 110 are waiting at crossing 106. As disclosed herein, the relevant influence factors may be analyzed in a machine learning approach to improve predictions.

As disclosed herein a first phase may include with crossing users 110 approach crossing 106. While approaching crossing 106, a spatio-temporal path 118 may be tracked. When a pedestrian, such as crossing user 110A, is walking, a prediction of a future location may be possible by predicting spatio-temporal path 118. For example, if crossing user 110A is directly heading towards a signaled crossing, such as crossing 106, he or she might plan to cross roadway 104. If crossing user 110A is using an app on mobile device 112 to navigate to a goal and agreed to share his or her route, the route information may be transferred to computing environment and used to improve the prediction.

As disclosed herein, object tracking may also be used to provide additional information about crossing users 110. For example, cameras 114 may provide images of crossing users 110's heads, faces, and/or eyes. By detecting head movement and/or gaze direction, crossing users 110's intent may be predicted. For instance, if crossing user 110A looks multiple times towards the other side of roadway 104, each time for a certain period of time, a crossing intent may be predicted. Crossing user 110A focusing on a pedestrian traffic light, such as infrastructure item 102, may also imply an intent to cross roadway 104. The longer a pedestrian is looking at infrastructure item 102, the more likely it may be that he or she wants to cross. Detecting an activity may be another aspect that might be used to predict behavior and/or intent. For example, someone who is sitting on a bench nearby a crossing might not be relevant as the person cannot cross while sitting down. However, should a second nearby infrastructure item change colors (i.e., from green to yellow to red) and the person stands up from the bench, the person may wish to cross roadway 104 and a behavior and/or intent may be inferred.

As disclosed herein, detecting a change in crossing users 110's behavior, especially during or after detecting that a pedestrian has looked at a traffic light can also be incorporated in an intent estimation. For example, if he or she started to walk or increased the walking speed when a traffic light switched to green, an intent to cross may be determined. Similarly, other external events may be used in predicting behavior and/or intent. If, for example, a tram or bus is just arriving at a stop or came into the view of crossing user 110A, a change in speed might give information that he or she wants to reach the tram or bus in time which might require crossing roadway 104 at crossing 106.

As disclosed herein, a history of previous predictions and their success may be used to improve algorithms used to predict behavior and/or intent over time. Temporal factors, such as time of day, day of the week, etc. may also be used in predicting behaviors and/or intents. For example, crossing users 110's behaviors may differ depending on time of day (e.g., rush hour) and weekdays vs. weekends and this information may also be incorporated as a factor in predicting behaviors and/or intents. Additionally, the direction from which crossing users 110 are approaching may be relevant, as there may be typical pedestrian flows at an intersection. For example, if there is an entry of a shopping center on one side and a train station entry on the other, a gaze of crossing user 110A may indicate an intent to go shopping if the current time is close to lunchtime. If the time is closer to the end of the workday, crossing user 110A's gaze toward the train station may imply an intent to board a train to go home.

The gaze, speed, and other data collected over time may be forwarded to computing environment 116 for analysis and to construct models for predicting behaviors and/or intents. For example, the various data collected may be stored as historical data 120. Using the data, models may be created that identify common paths pedestrians may travel, a speed at which pedestrians travel for given locations proximate crossing 106.

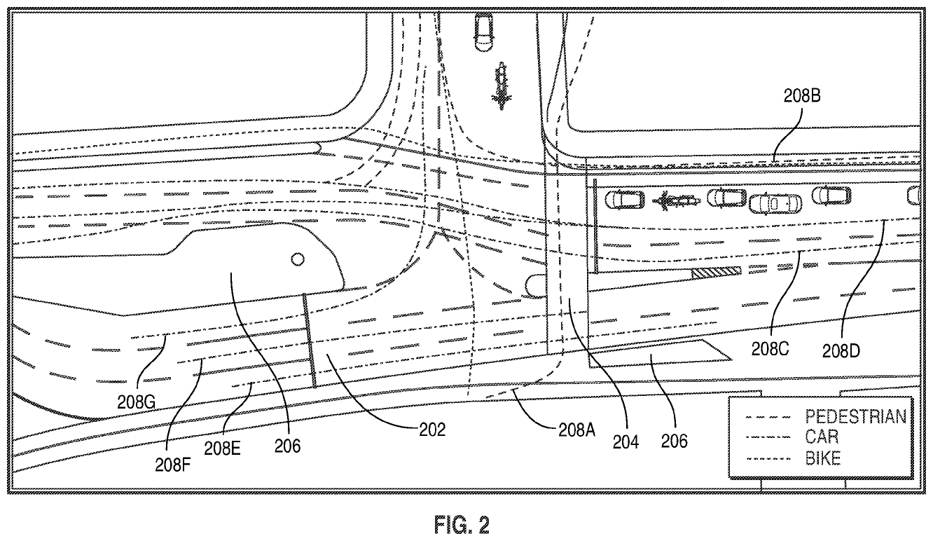

As disclosed herein, the common paths, speeds, and other historical data may be used to create a heatmap 200 such as shown in FIG. 2. Heatmap 200 may define a boundary for a roadway 202 having a crossing 204. The boundary for roadway 202, crossing 204, and any other structures, such as medians 206 may be defined by coordinates specified in one or more geofences.

Heatmap 200 may also include data that defines one or more paths 208 (labeled individually as paths 208A, 208B, . . . 208G). Paths 208 can include path 208A in which crossing users 110 may use to cross roadway 202 and/or travel in proximity to roadway 202 (e.g., on sidewalks). Paths 208 may also include a bike path, such as path 208B as well as paths 208C, 208D, 208E, 208F, and 208G for automobiles.

As disclosed herein, for each of paths 208 a velocity distribution may be stored for pedestrians, bicycles, scooters, vehicles, etc. This information can be used to correlate a current path of crossing user 110A with heatmap 200 and determine whether he or she is likely to cross roadway 202.

Groups of people may also be detected and/or treated as a single entity. For example, a group of pedestrians, such as crossing users 110B-110E may be detected. Detection of a group may be accomplished by determining that everyone in the group travels at the same speed, has a previous similar path, and/or same heading changes. Other factors such as facial tracking and determining those various members are turning to face one another or speaking in a direction toward one another may also indicate the various individuals are part of a group with a similar destination. In crowed areas, sensors and cameras may allow for tracking over a longer time period to aid in the detection of groups. Using the same intent detection methods as for single pedestrians, a group-wise intent might get calculated, for example by detecting a lead person or by a majority.

In addition to sensors and cameras that collect environmental data in real-time, other data sources 222 may provide data to aid in formulating prediction models and/or predicting behavior and/or intent. For example, other data sources 222 may include calendar information, route selections, etc. crossing users 110 shared with one another or an operator of system 100. For example, crossing user 110A may have shared calendar data that identifies a location in which crossing user 110A is planning to be at a certain time. Based on knowing the expected location and the current location of the crossing user 110A, an expected route can be estimated and used to determine an intent to cross roadway 104 at crossing 106.

As disclosed herein, a second phase may include when crossing users 110 are waiting at crossing 106. Detecting crossing users, such as crossing users 110B-110E, waiting at crossing 106 may be performed as described above with respect to a crossing user, such as crossing user 110A, approaching crossing 106. For example, cameras 114 may capture images of crossing users standing in close proximity to one another and/or crossing 106. The lack of motion of the crossing users in combination with a light 124 of infrastructure item 102 being red may indicate an intent to cross roadway 104 once light 124 turns green. Again, pose and gaze direction towards crossing 106 and the activity may be relevant to determining if a person is waiting to cross as disclosed herein.

Additional sensors, such as proximity sensors (e.g., using Bluetooth or WIFI sensors), may be used to improve an estimation of people waiting. For example, a pedestrian that is waiting for a green traffic light could be detected because the Bluetooth signal strength is not changing much over time. Another aspect that may be incorporated into the crossing demand is a crossing urgency detection. By analyzing the gaze direction and behavior of crossing users 110 it may be possible to estimate a patience score. For example, no or slow movements may be seen as a relaxed mood and patience while multiple gaze direction changes or movements might be effects of impatience and a desire to cross quickly.

In addition to predicting behavior and/or intent of VRUs, such as crossing users 110, behavior and/or intent of other traffic participants may be determined. By predicting behavior and/or intent of other traffic participants, the trajectories of non-VRU may be estimated. The trajectories, behaviors, and/or intent may be used to optimize traffic flows. For example, a flow optimization and traffic controller 126 may receive route data from other sources 122, historical data 120, and sensors, such as cameras 114 and sensors within vehicles, such as vehicle 108, to predict behaviors and/or intent of vehicles traveling on roadway 104. Examples of other sources 122 may include data from business and transportation entities. For example, train/bus schedules, timetables of cinemas or theatres may be used as sources of data to predict destinations for pedestrians.

As part of flow optimization and traffic controller, flow optimization and traffic controller 126 may interface and exchange data with historical data 120, other data sources 122, and a simulator 128. Simulator 128 may simulate various scenarios using possible paths crossing users 110 and vehicles may take. Using data from simulator 128, flow optimization and traffic controller 126 may transmit signals to infrastructure items, such as infrastructure item 102, to control a flow of traffic and pedestrians. For example, using data from historical data 120 that indicates crossing user 110A routinely crosses roadway 104 using crossing 106, flow optimization and traffic controller 126 may transmit a signal to change a phase of light 124 from green to red to force vehicle 108 to stop and allow crossing user 110A to cross roadway 104 without any delays.

As disclosed herein, vehicles may include sensors and have their own detections/predictions. Sensors of smart devices, such as mobile device 112, may also provide data used to predict crossing user 110A's behavior and/or intent. The data received from vehicles and crossing users 110 may be compared along with predictions and/or intents to help improve trustworthiness of the predictions and/or intents. For example, if telemetry data from vehicle 108 shows a driver is pressing the brake pedal and data from mobile device 112 shows crossing user 110A approaching crossing 106, a prediction that vehicle 108 intends to stop so that crossing user 110A can cross roadway 104 may be confirmed. As disclosed herein, messages can be transmitted to vehicle 108 of crossing user 110A's intent to use crossing 106 and an acknowledgement message may be transmitted to mobile device 112 to inform crossing user 110A that vehicle 108 intends to stop to allow crossing user 110A to cross.

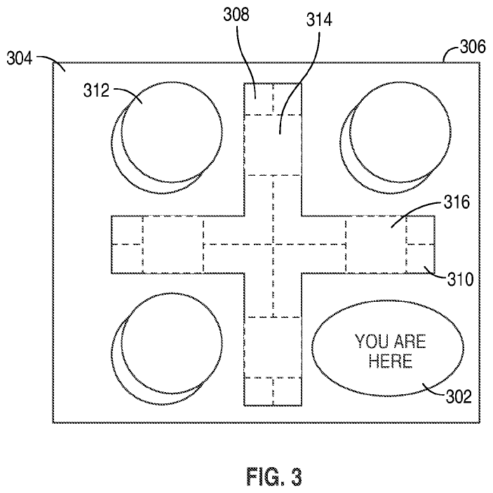

Other data can be used to increase trustworthiness of predictions as well. For example, crossing user 110A may press a button on infrastructure item 102 to request a green light at crossing 106. Crossing users 110 may also indicate a need to make more than one crossing. For example, and as shown in FIG. 3, a crossing user may be located at a first location 302 and wish to travel to a second location 304 depicted on a screen 306. To reach second location 304, the crossing user may have to cross both first roadway 308 and second roadway 310. By pressing a button 312 on screen 306, the crossing user may signal an intention. Flow optimization and traffic control 126 may use the data received via the input from the crossing user to better optimize traffic on roadways 308 and 310 to minimize delays for vehicles, pedestrians, or both. For example, flow optimization and traffic controller 126 may use telemetry data (e.g., speed, routing information, etc.) to calculate times at which vehicles may reach crossings 314 and 316. Based on the estimated times, flow optimization and traffic controller 126 may changes one or more settings on infrastructure items to minimize delays for pedestrians and/or vehicles.

As disclosed herein, computing environment 116 may use historical data 120 along with simulations to learn. Thus, computing environment 116 may learn which data may lead to a false positive for a predicted behavior and/or intent in order to avoid misdetections and/or predictions.

As disclosed herein, predictions of behavior and/or intent can be continuously updated. For example, a miss to predict an intend of crossing user 110A to cross roadway 104 may be updated as crossing user 110A is approaching infrastructure item 102 and crossing 106 and new data is received. Thus, the confidence of the crossing intent may be determined and/or changes based on updated data.

As disclosed herein, when a misdetection and/or prediction occurs learning can take place. For example, continuous learning algorithms may be implemented by computing environment 116 using continuously updated data to increase precision over time. While the intent predictions described herein may be complex, requiring advanced recognition algorithms, the validation of the result is simple. The path of crossing users 110 can be recorded and compared with the predictions. Thus, using the predictions and what actually occurs, computer environment may be a self-learning system.

The flow optimization and traffic control may be done by a central service as shown in FIG. 1. For example, computer environment 116 may use a pre-defined schedule of green phases as a baseline and adapt according to both vehicle traffic and pedestrian traffic demands. For instance, using sensors like induction loops embedded in roadway 104 as presence sensing for vehicles and data from crossing users 110 (e.g., from mobile device 112) and cameras 114, proposed path and intent predictions for flow optimization and traffic controller 126 may, in real-time, determine durations for red and green phases of traffic lights. Therefore, a crossing demand score over time may be calculated which depends on multiple aspects.

For waiting pedestrians, the demand may raise by the amount of people waiting and how long they have been waiting. For moving pedestrians with a detected crossing intent, the predicted spatio-temporal path may be used to calculate an ideal green phase timing. By applying this calculation for all pedestrians and finding similarities, an overall schedule may be calculated that fits best for all traffic participants.

By continuously monitoring the situation and storing historical data 120, an overall calculation may be improved over time. By creating various heatmaps, such as heatmap 200 for one or more crossings, typical paths may be identified, even if those paths are not formal paths. For example, a typical path may be crossing users 110 jaywalking and crossing roadway 104 in undesignated crossing areas. As typical paths may change depending on the environment (e.g., time of day, weekday, weekend, weather, train arriving, etc.) multiple heatmaps might be created. The selection may then be done by measuring and comparing relevant aspects with the current state to one or more heatmaps and selecting the heatmap created with data most closely matching the current state.

Spatial concerns may also be considered. For example, in a crowded area, a pedestrian refuge island, such as medians 206, may not provide enough room to hold all VRUs that plan to cross. Flow optimization and traffic controller 126 may therefore use a number of pedestrians and their predicted locations to dynamically adjust a green phase to reduce the number of VRUs that may be located on a pedestrian refuge island in between lanes of traffic.

As disclosed herein, priority may be given to pedestrian or vehicular traffic. For example, in specific areas pedestrians may have a higher priority than vehicles (e.g., in city centers) and in others, vehicles may have priority (e.g., in rural areas).

Accident reduction and/or prevention may also be achieved using they systems and methods disclosed herein. For example, by predicting behaviors and/or intents of VRUs and vehicles, the green phase of lights may be reduced and/or skipped if an unsafe situation is predicted. For example, if a vehicle is approaching a pedestrian crossing at a high rate of speed, such as exceeding the speed limit, the stopping distance for the vehicle may be calculated and if the stopping distance, with a safety factor included, is not sufficient for the vehicle to stop without passing through the crossing, the signal for the pedestrian crossing may stay red to signal to the pedestrians it is not safe to cross. A warning signal, acoustic or visual, may also be triggered to warn pedestrians.

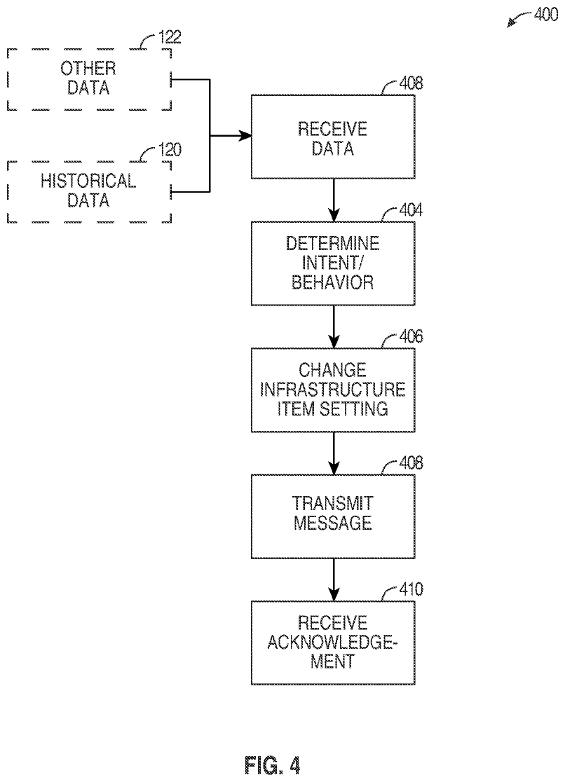

FIG. 4 shows a method 400 for controlling an infrastructure item, such as infrastructure item 102, located proximate a crossing, such as crossing 106, in accordance with at least one example of this disclosure. Method 400 may begin at stage 402 where data, such as environmental data, may be received. As disclosed herein, the environmental data may include data from the environment proximate the crossing and/or infrastructure item. The data may be received by cameras, from smart devices, etc. The environmental data may capture behavior of a crossing user, such as crossing users 110. As disclosed herein, receiving data may also include receiving historical data 120 and other data 122.

As disclosed herein, receiving the environmental data may include receiving route data from a mobile device of the crossing user. For example, a pedestrian may have planned a route to a destination using his or her mobile device. As the pedestrian walks to his or her destination, his or her mobile device may share the route data, and thus a projected course, with infrastructure devices and/or remote computing devices. Using the route data, a projected course of the pedestrian may be determined.

Receiving the environmental data may include receiving images of the crossing user from one or more cameras located proximate the crossing. For example, cameras located proximate the crossing may capture and transmit images of the crossing user. The images may be used in conjunction with object tracking to determine a route and/or trajectory of the crossing user.

Receiving the environmental data may include receiving telemetry data from a modality of transportation operated by the crossing user. For example, the crossing user may be riding a bicycle or e-scooter. The bicycle or e-scooter may transmit speed, heading, and/or route information, which may be used to determine a behavior and/or intent of the crossing user.

As disclosed herein, receiving the environmental data may include receiving telemetry data from one or more vehicles operating in a roadway proximate the crossing. For example, vehicles operating proximate the crossing may transmit telemetry data such as speed, heading, and/or route information. The telemetry data may be used to determine when a vehicle may pass through a crossing based on, for example, speed and heading.

Using the data, an intent of the crossing user may be determined based on the data (404). For example, determining the intent of the crossing user may include determining a projected course of the crossing user based on the data. For instance, the data may include images of crossing user, and determining the intent of the crossing user may include determining a projected course of the crossing user by tracking and object associated with the crossing user (e.g., a hat, article of clothing, face, eyes, etc.) within the images of the crossing user.

The crossing user's intent and/or behavior may also be determined based on tracking one or more facial features. For instance, as disclosed herein, the crossing user's eyes may be tracked and a gaze of the crossing user may indicate the crossing user is looking at the crossing and also constantly checking vehicular traffic in the roadway. Based on this information, a determination may be made that the crossing user intents to cross the roadway and may have a predicted behavior of stepping into the roadway upon reaching the crossing.

Determining behavior and/or intent of crossing users may include performing simulations as disclosed herein. For example, using models, simulations, such as Monte Carlo Simulations, may be performed to determine which of a plurality of paths a crossing user may travel. The simulations may be performed using other data 122 and/or historical data 120. For example, historical data 120 may indicate that a user with a particular gaze pattern crosses a roadway 85% of the time. Thus, when a crossing user exhibits the particular gaze pattern, the simulation may predict that there is at least an 85% chance the crossing user will cross the roadway.

Once a behavior and/or intent has been determined, a setting of the infrastructure item may be changed based on the intent of the crossing user (406). For example, a light of the infrastructure item may be changed from a first state to a second state based on the intent of the crossing user. For instance, the light may be changed from green to red to stop traffic so the crossing user can cross.

Changing the setting of the infrastructure item may include transmitting a command to at least one of a traffic signal and a crosswalk signal. For example, a command may be transmitted to a traffic signal to change the signal from a first state to a second state. For example, a command may be transmitted to a traffic signal to change the signal from a green phase to a red phase. A command may be transmitted to the crosswalk signal to change the crosswalk signal from a red phase to a green phase. Stated another way, the first state may be a red or green phase and the second state may be a green or red phase.

Changing the setting of the infrastructure item may include changing a phase of at least one of a traffic signal and a crosswalk signal. For example, changing the setting of the infrastructure item may include changing a duration of a lighting phase of the traffic signal and the crosswalk signal. For instance, the crossing user may be approaching a crosswalk signal that is green. To allow the crossing user to cross, the duration of the green phase may be extended while simultaneously extending a red phase.

As disclosed herein, a message may be transmitted (408). For example, a message may be transmitted to at least one of a mobile device and a smart wearable of the crossing user. A message may be transmitted to one or more vehicles operating proximate the crossing. The messages transmitted may include information regarded the determined behavior and/or intent. For example, the messages may include information that the computing system determined the crossing user intents to cross the roadway at the crossing. The messages to vehicles may include information that tells the vehicles, or their drivers, that a crossing user may intent to cross the roadway at the crossing and an expected behavior associated with the intent.

In response to the transmitted messages, an acknowledgement may be received from at least one of or each of the one or more vehicles in response to receiving the message (410). The acknowledgement may include data indicating the one or more vehicles have received the messages transmitted in stage 408. The acknowledgement message may include data that indicates a behavior of the vehicle in response to the message received in stage 408. For example, in response to the message in stage 408 that a crossing user intents to cross a roadway, the acknowledgement message in stage 410 may include information that the vehicle intents to stop at the crossing to allow the crossing user to cross. Method 400 may be executed continuously. For example, data may be received continuously and behaviors and/or intents updated based on the new data received. As the behaviors and/or intents are updated, the settings of the infrastructure items may be updated accordingly.

The various stages of method 400 have been described in a particular order, but one skilled in the art will understand that the various stages may be reordered and/or omitted. For example, stages 408 and 410 may be executed prior to changing the infrastructure setting item (406). For instance, a message may be transmitted to vehicles (408) and acknowledgements received (410). In response to the acknowledgements, the infrastructure item setting may be changed based on coordinated actions of the vehicles and crossing users.

Reducing fatalities and serious injuries to zero in a future intelligent transportation system (ITS) is an ambitious goal referred to herein as “Vision Zero.” Safety of VRUs such as pedestrians, kids, cyclist, scooter riders, etc. is a factor in achieving a Vision Zero policy. It has been estimated that the chances of VRUs getting killed or injured in a collision is at least 250 times more likely than a motorist. The systems and methods disclosed herein may predict behavior and/or intent of VRUs to enhance safety of the VRUs. The systems and methods disclosed herein may provide preventive measures coordinate traffic lights and other infrastructure among vehicles, VRUs, and other infrastructure using V2X communication to reduce fatalities and serious injuries of VRUs, at a reasonable cost, while sustaining the usefulness and throughput of the road system.

As disclosed herein, VRU safety enhancement, sometimes referred to as “informed and interactive VRU crossings,” may coordinate with vehicles, VRUs, and infrastructure node to provide enhanced safety for VRUs and vehicles alike. For example, sensors may collect data from VRUs and vehicles. The data may be used to predict a behavior and/or intent of a VRU. Using the predicted behavior and/or intent, traffic lights may be changed from red to green, green to red, etc. to provide safe flow of traffic for both vehicles and VRUs.

As disclosed herein informed and interactive VRU crossings (IIVCs) may enable safe and informed road/street/highway/intersection crossing of VRUs whereby VRUs first share intention to cross a road/street/highway/intersection and get ‘go ahead’ confirmation from nearby vehicles as disclosed herein. A VRU (e.g., pedestrian, cyclist, etc.) may express an intent a to cross road/street/highway/intersection/etc. when it is ready to cross a road or street. Vehicles approaching the area in which the VRU intends to cross may receive a message and send an acknowledgment when the vehicles have begun to slow down or after stopping to allow the VRU to cross safely. Upon receiving this acknowledgment from the vehicles, the VRU may cross the street. Upon reaching the other side of the street, the VRU may send another message to the vehicles confirming that they have safely crossed. For example, safe and efficient IIVCs may allow for vehicles approaching VRU-crossing area to receive a VRU's intention to cross and all associated vehicles in a geo-area around the crossing-zone may acknowledge agreeing to let VRU cross.

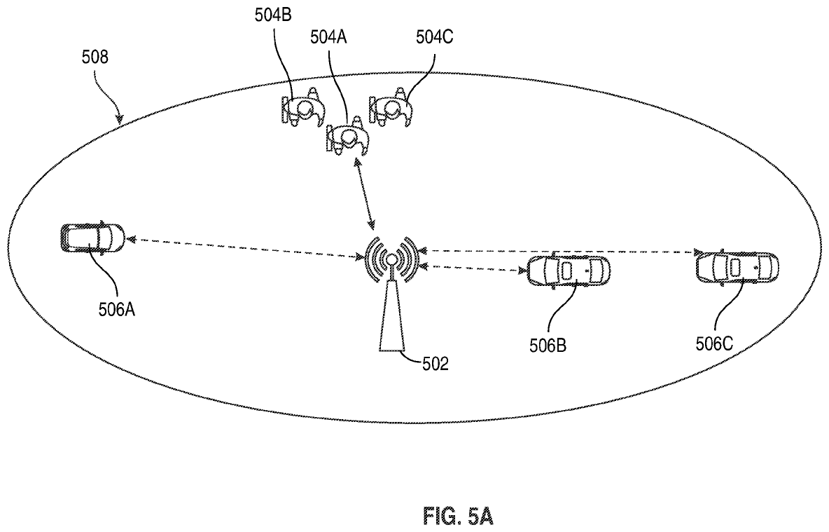

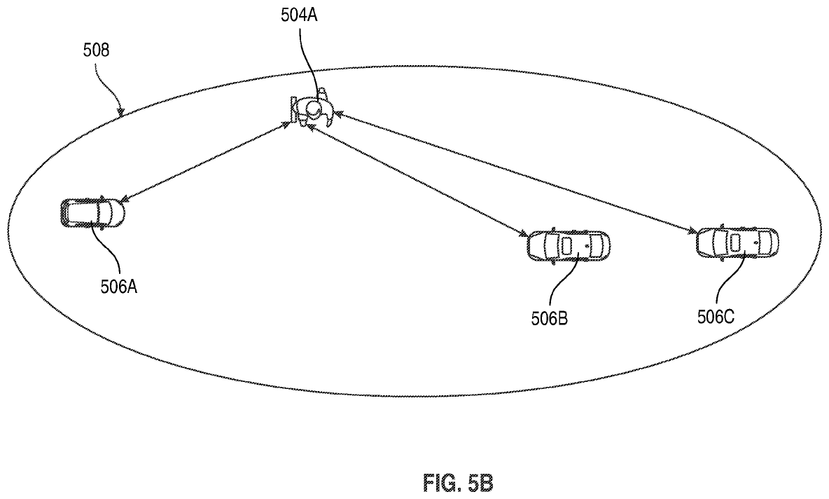

Turning now to FIGS. 5A and 5B each shows an example use case scenarios showing negotiation and coordination for informed and interactive VRU crossing in accordance with at least one example of this disclosure. FIG. 5A shows a roadside unit (RSU) 502, which may be a component of an infrastructure item, assisted negotiation between one or more crossing users 504 (labeled individually as crossing users 504A, 504B, and 504C) and one or more vehicles 506 (labeled individually as vehicles 506A, 506B, and 506C). For example, RSU 502 may be computing environment 116, which may be a component of infrastructure item 102. FIG. 5B shows a distributed implementation, such as shown in FIG. 1, where computing environment 116 is not a component of infrastructure item 102. Regardless of the location of computing environment, the operations as shown in FIGS. 5A and 5B may be similar. For instance, as shown in FIG. 5A, RSU 502 may receive the various environmental data as disclosed herein and determine behaviors and/or intent to control infrastructure items. In FIG. 5B, infrastructure items may receive the environmental data and transmit it to a remote computer, such as an edge and/or cloud computer that may determine behaviors and/or intent. The edge and/or cloud computer may then transmit signals to infrastructure items to change one or more settings and/or states of the infrastructure items as disclosed herein.

As disclosed herein, when crossing users 504 and/or vehicles 506 are within a geographical area 508 various infrastructure items may be controlled as disclosed herein. For example, as shown in FIG. 5A, when crossing users 504 and/or vehicles 506 are within geographical area 508, RSU 502 may receive environmental data from crossing users 504 and/or vehicles 506 to control traffic and/or pedestrian lights located proximate RSU 502 and/or within geographical area 508. As shown in FIG. 5B, when crossing users 504 and/or vehicles 506 are within a geographical area 508 environmental data may be transmitted to a remote computer 510, that may include computing environment 116 to control traffic and/or pedestrian lights within geographical area 508. Geographical area 508 may be defined by a collection of coordinates that specify a geofence.

As disclosed herein, vehicles 506 and/or crossing users 504 may interact with infrastructure nodes, such as RSU 502 and/or each other to negotiate crossings. For example, a V2X message, such as a VRU awareness message (VAM), personal safety message (PSM), etc. may be used for informing road users about intention of VRU(s) crossing road/street/intersection and interaction among road users to facilitate safe VRU crossing. Continuous communication with on-going VRU crossing indications may be used after negotiation between vehicles 404 and/or crossing users 404 during actual crossing to help maintain VRU safety as newcomer vehicles which may not have been present during the IIVC negotiation. The on-going VRU crossing indications may include existing periodic messages (VAM, PSM) transmitted from VRUs as well as in other existing V2X messages (e.g., collective perception messages (CPMs), maneuver coordination messages (MCM), basic safety messages (BSM), cooperative awareness messages (CAM), infrastructure-VAM, vehicle-VAM, decentralized environmental notification messages (DENM), etc.,) transmitted to and/or from vehicles and/or infrastructure in the proximity.

Once a VRU crosses safely, he or she, via a wearable or other mobile device, may indicate, such as via VAM, PSM, etc., to vehicles and infrastructure nodes that he or she has cleared the crossing so that the vehicles may continue driving. To help overcome positioning error and small errors that may result in false indication of crossing complete (i.e., VRU is still on road/crossing when he or she reports crossing completed), vehicles may use individual perception based on on-board sensors and/or by collective perception by sharing perception among proximate vehicles and infrastructure nodes to confirm the VRU has cleared the crossing. If smart infrastructure is present in the proximity (such as RSU 502), the smart infrastructure may act in a coordinator role to receive perceptions from various sources to confirm the VRU has cleared the crossing. For example, infrastructure assists conveying VRU-crossing status based on infrastructure sensing and perception may coordinate various messages between the various vehicles and VRUs.

Infrastructure may also warn and recommend maneuver change to specific vehicles when the infrastructure detects and/or determines that a vehicle's current or planned maneuver may endanger a VRU. For example, if a projected location of a vehicle, based on trajectory and speed, places the vehicle in the crossing within a range of times in which the VRU is expected to be in the crossing, a message may be transmitted to the vehicle indicated the vehicle should slow down to avoid the VRU. A corresponding message may be transmitted to the VRU to warn the VRU of the approaching vehicle for situational awareness.

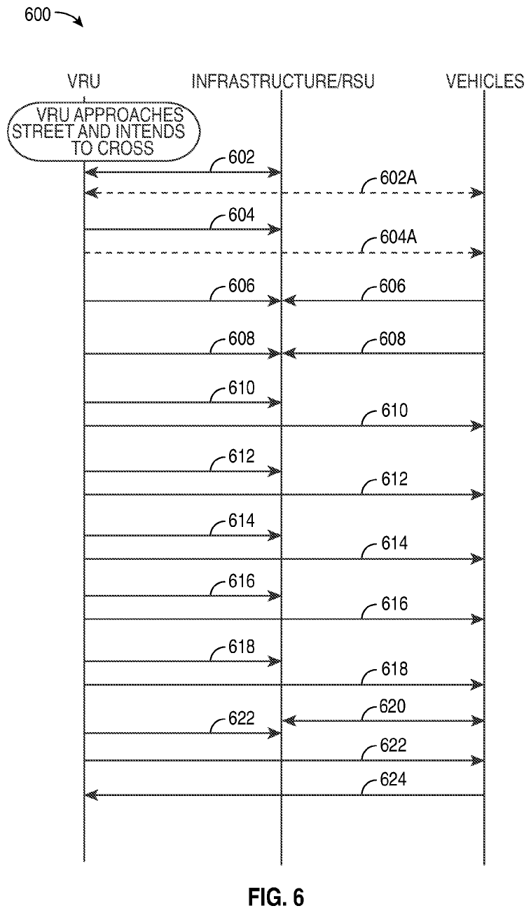

As disclosed herein, the collaboration between VRUs and vehicle may be in a distributed manner, such as shown in FIG. 5B, where the negotiation and coordination for informed and interactive VRU crossing may occur when infrastructure may or may not present in the VRU crossing zone. FIG. 6 shows a method 600 for informed and interactive VRU crossing when an RSU is present in a crossing-zone in accordance with at least one example of this disclosure.

When VRU approaches a crossing with an intent to cross, the VRU and infrastructure may acquire positioning and/or map data (602). Based on a VRU profile, some VRUs may be capable of getting this information based on local on-board sensors, while others may receive data from proximate vehicles (602A) or from sensors associate with one or more infrastructure items.

As disclose herein VRUs may broadcast or geo-cast informed-interactive-VRU-crossing-requests (IIVC-Req) in a V2X message (e.g., VAM, PSM, etc.) indicating its intention to cross a road/street/intersection to infrastructure (604) and/or to vehicles (604A). IIVC-Req may include details of the VRU's crossing such as the VRU's current position, average speed, crossing zone (e.g., crossing location, direction, etc.), a VRU's profile, IIVC-collaboration-geo-area information (e.g., such as 500 m around the crossing zone/line), etc. If infrastructure is present, the VRU may receive assistance from infrastructure/RSU to decide content of IIVC-Req. The IIVC-Req may also request an acknowledgement (ACK) from vehicles, RSUs, infrastructure, etc. in IIVC-collaboration-geo-area by setting an ACK-requested field in IIVC-Req (606).

As disclosed herein, an IIVC-Req-Id may be included in an IIVC-Req so that multiple IIVCs going in the proximity may be distinguishable from one another. For example, IIVC-Req-Ids may to be unique in the local geo-area. Thus, IIVC-Req-Ids may be derived from one or more of VRU-ID, VRU-Type (i.e., pedestrian, bike, e-scooter, etc.), crossing location coordinates, crossing direction, etc. For instance, IIVC-Req-Ids may be a hash of various data so as to anonymize user data, while still allowing infrastructure/RSU's to direct messages accordingly.

IIVC-Req may be repeated periodically with a period (T-Req-Period) for a pre-defined number of times (N-Req-Repeat) to ensure at least one copy of IIVC-Req is received by all vehicles/RSUs in the IIVC-Collaboration-Geo-Area. The repeating of message transmission may improve reception reliability when vehicles/RSUs have half-duplex radio.

As disclosed herein, vehicles and RSUs (if present) may send ACK messages (608), in an IIVC response (IIVC-Res) individually in a V2X message. Vehicles and RSUs may repeat a specific number of ACK messages (N-ACK-Repeat). Repeatedly transmitting ACK messages may be allowed when devices do not operate in full duplex modes to participate in message exchanges. Thus, if a receiving device is transmitting a message when an ACK message is sent by a vehicle or RSU, the receiving device may receive the ACK message during a subsequent transmission of the ACK message.

Vehicle/RSU may include an associated IIVC-Req-Id in IIVC-Res so that it clearly indicates a response to a specific IIVC-Req. For example, if multiple simultaneous IIVCs are going on, vehicles/RSUs may indicate acknowledgement via ACK messages to more than one IIVC-Reqs by including more than one IIVC-Req-Ids. Each vehicle/RSU may also include its own id (e.g., a Node-Id) so that VRUs may keep track of confirmations from specific vehicles/RSUs. Vehicles may also include other information such as current location, vehicle type, dimension, etc.

Vehicles/RSUs may indicate any discrepancy in information shared by VRUs in IIVC-Req. For example, vehicles/RSUs may indicate an error in a VRU's position. Vehicles may also indicate specific information relevant to IIVC. For example, a vehicle may indicate that it is the frontmost vehicle in a lane for a crossing zone indicated in IIVC-Req.

As disclosed herein, vehicles/RSUs may retransmit IIVC-Res multiple times. For example, vehicles/RSUs may transmit IIVC-Res messages N-ACK-Repeat times if ACK-confirmation messages are not received from vehicles within a pre-defined time after sending each IIVC-Res. A retransmit flag with a retransmission number may be set in retransmitted IIVC-Res.

After sending an ACK message to confirm a VRU's crossing, vehicles/RSUs may continue transmitting on-going IIVC negotiation notification with IIVC-Req-Id and additional information, such as crossing-zone information, etc. in its regular periodic/event-based messages. For example, on-going negotiation notifications may be conveyed using CPMs, MCMs, Vehicle-VAMs, DENMs, CAMs/BSMs, etc. to make new vehicles entering a IIVC collaboration geo-area aware of the on-going VRU crossing negotiation.

When multiple simultaneous IIVCs are going on, vehicles and RSUs may indicate notification for more than one IIVCs by including more than one IIVC-Req-Ids. VRUs then sends ACK-Confirmation (IIVC-Res-Confirmation) in a V2X message, such as VAM, PSM or a new message, to acknowledge IIVC-Res messages (610). As disclosed herein, ACK-Confirmation may contain IIVC-Req-Ids and Node-Ids to indicate confirmation of reception of a specific IIVC-Res. ACK-Confirmations may be sent within a pre-defined time (e.g., a max-ACK confirmation wait time) after reception of IIVC-Res from vehicles/RSUs. If a vehicle/RSU does not receive ACK-Confirmation within this time for its IIVC-Res, the vehicle/RSU may retransmit IIVC-Res (612).

As disclosed herein, a VRU may groupcast Group-ACK-Confirmation acknowledging multiple IIVC-Res from multiple vehicles/RSUs. A Group-ACK-Confirmation may contain multiple IIVC-Req-Id and multiple Node-Ids. VRUs may ensure a Max-ACK-Confirmation-Wait is satisfied for all vehicles/RSUs included in the Group-ACK-Confirmation.

Once a VRU receives an IIVC-Res message from all (or most) of the vehicles (e.g., from frontmost vehicles in all lanes) and RSU, if present, the VRU may start crossing the road/street. The VRU may get assistance from RSU to decide when to cross by receiving messages as disclosed herein. A VRU may send a crossing start indication before crossing (614). For example, a mobile device of the VRU may transmit the crossing start indication to vehicles and/or RSU as disclosed herein. For instance, a VRU may send crossing start confirmation in a V2X message (e.g., in a VAM, PSM, etc.) to indicate success of negotiations and the start of VRU crossing the roadway. Crossing start confirmation may include IIVC-Req-Ids. The VRU may repeat crossing start confirmation for a pre-defined number of times (e.g., N-Crossing-Start-Confirmation-Repeat) before starting to cross to ensure vehicles and RSUs receive the message.

If a crossing start confirmation is not sent within a given time, such as a max wait time for crossing start confirmation (e.g., >=T-Req-Period*N-Req-Repeat) after first transmission of IIVC-Req, vehicles/RSUs may assume failure of negotiation and may continue as previously planned. Vehicles may send a “negative acknowledgement” (NACK) with IIVC-Req-Ids to the VRU before moving ahead. The VRU may need to restart IIVC negotiation by restarting method 600.

If lead or otherwise vehicles closest to a crossing in all lanes in both directions proximate and approaching the crossing have acknowledged to stop at the crossing, the VRU may send the crossing start confirmation (614) without waiting for ACK messages from rear vehicles behind the front vehicles, as these must also stop to avoid collisions.

Once the VRU starts crossing, he or she may periodically send an IIVC status update message to vehicles/RSUs (616). The status update messages may include IIVC-Req-Ids and updated location, speed, direction, etc. information for the VRU. After receiving Crossing-Start-Confirmation, vehicles/RSUs may include “On-going VRU Crossing” notification with IIVC-Req-Id in its regular periodic/event-based ITS messages, such as CPMs, MCMs, Vehicle/RSU-VAMs, DENMs, CAM/BSMs, etc.) to make new vehicles entering IIVC-Collaboration-Geo-Area aware of On-going VRU Crossing. If multiple simultaneous IIVCs are going on, vehicles/RSUs may indicate notification for more than one IIVCs by including more than one IIVC-Req-Ids. Once the VRU crosses the road/street, he or she may transmit an IIVC complete ACK message to the vehicles/RSUs for a pre-defined time (618).

The VRU may have positioning error resulting in false indication of crossing complete (i.e., VRU is still on road/crossing when it reports crossing completed). Vehicles and RSUs should ensure the VRU has crossed the road/street by individual perception based on on-board sensors or by collective perception service (CPS) by sharing perception among proximity vehicles and infrastructure nodes/RSUs (if present) (620).

In crossing start confirmation messages, the VRU may indicate an estimated time to complete IIVC and continuously update the estimated time via one or more messages (622). If the IIVC complete ACK message is not received within the estimated completion time since the last updated estimated completion time has been received by the vehicles/RSU, the vehicles and RSUs may utilize on-board sensing to confirm completion status.

Once vehicles and RSUs confirm the VRU has completed the crossing, the vehicles/RSUs may transmit a VRU crossing completed message with IIVC-Req-Id in its regular periodic/event-based ITS messages, such as CPMs, MCMs, Vehicle-VAMs, DENMs, CAMs/BSMs, etc., for a pre-defined number of times to let the VRU know they know the VRU has completed the crossing (624). Depending on the VRU's progress in completing the crossing, signal phase may be adjusted for the vehicles as disclosed herein.

As disclosed herein, after VRU broadcast and/or geo-cast interactions in a V2X message, such as VAMs, PSMs, etc., indicating intentions to cross a road/street/intersection as disclosed herein, first responding vehicle may send IIVC ACK (IIVC-Res) messages declaring itself as a collaboration leader. Thus, the first responding vehicle may communicate with other vehicles to relay various messages. Thus, bandwidth and latency may be reduced by allowing vehicles to communicate with one another and having a single vehicle communication with infrastructure item/RSU and/or VRUs. For example, the collaboration leader may coordinate with other vehicles in the collaboration area and/or within a geo-area via V2X message (e.g., CPS, MCS, Vehicle-VAMs, etc.) and confirms negotiation with the VRU and/or other vehicles.

When a vehicle approaches that does not have messaging capabilities, a negotiation with the vehicle may not be feasible. In that case, the collaboration leader may detect and warn the VRU of such vehicles and wait until those vehicles come to a stop before sending ACK messages.

In instances when an infrastructure item is present, the infrastructure item may serve as the collaboration leader. The infrastructure item may have a priority over vehicles to serve as collaboration leader. For example, when both a vehicle and an infrastructure item serve as the collaboration leader, the infrastructure item may have priority over the vehicle and serve as the collaboration leader.

When a VRU is detected that does not have the capabilities to transmit and receive messages as disclosed herein, the infrastructure item may act as a collaboration leader for transmitting and receiving messages of method 600 in place of VRU. By acting as the collaboration leader, the infrastructure may transmit and receive messages on behalf of the VRU to negotiate with vehicles so that VRU may cross the roadway safely. For example, infrastructure item may initiate the IIVC on behalf of the VRU. The infrastructure item may send an IIVC-Req message or IIVC crossing start confirmation message to vehicles to inform them of potential or ongoing VRU crossings by a communication-incapable VRU. When the infrastructure item has the capability of providing visual or audio notification (e.g., siren, flashing lights, etc.), the infrastructure item may activate them during the VRU's crossing for communication-incapable vehicles.

When a group of VRUs has been detected, one of the VRUs may be selected or self-elect itself as the cluster leader to coordinate IIVC with vehicles. By acting as the cluster leader, the selected VRU may exchanges messages as disclosed with respect to method 600 on behalf of the group instead of having each VRU have to transmit and receive messages to coordinate the crossing.

The various embodiments disclosed herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the -readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software: the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture

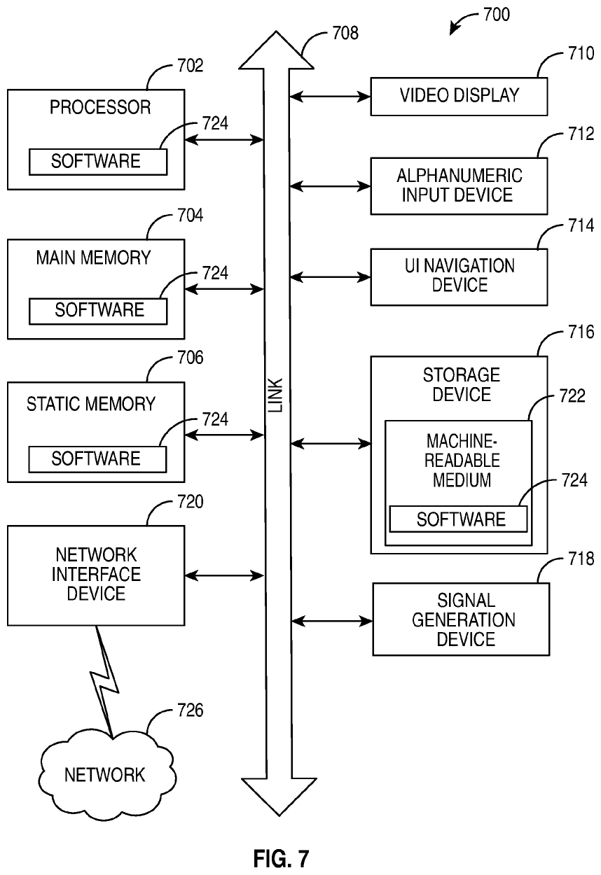

FIG. 7 is a block diagram illustrating a machine in the example form of a computer system 700, within which a set or sequence of instructions may be executed to cause the machine to perform any one of the methodologies discussed herein, according to an embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a vehicle subsystem, a personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 may further include a video display unit 710, an alphanumeric input device 712 (e.g., a keyboard), and a user interface (UI) navigation device 714 (e.g., a mouse). In one embodiment, the video display unit 710, input device 712 and UI navigation device 714 are incorporated into a touch screen display. The computer system 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, gyrometer, magnetometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, DSRC, or Satellite (e.g., low-earth orbit) networks). The term “transmission medium” shall be taken to include any intangible medium that is capable of storing, encoding, or carrying instructions for execution by the machine, and includes digital or analog communications signals or other intangible medium to facilitate communication of such software.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety re-lated applications in the frequency range 5,875 GHz to 5,905 GHZ), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHz)), DSRC in Japan in the 700 MHz band (including 715 MHz to 725 MHZ), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHZ and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHZ (note: allocated for example in China), 790-960 MHz, 1710-2025 MHz, 2110-2200 MHZ, 2300-2400 MHZ, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHZ, 3400-3800 MHZ, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHZ (note: allocated for example in South Korea, 5925-7125 MHz and 5925-6425 MHz band (note: under consideration in US and EU, respectively. Next generation Wi-Fi system is expected to include the 6 GHz spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHZ, 3800-4200 MHZ, 3.5 GHz bands, 700 MHz bands, bands within the 24.25-86 GHz range, etc.), spectrum made available under FCC's “Spectrum Frontier” 5G initiative (including 27.5-28.35 GHZ, 29.1-29.25 GHz, 31-31.3 GHZ, 37-38.6 GHz, 38.6-40 GHZ, 42-42.5 GHZ, 57-64 GHz, 71-76 GHz, 81-86 GHZ and 92-94 GHZ, etc), the ITS (Intelligent Transport Systems) band of 5.9 GHZ (typically 5.85-5.925 GHZ) and 63-64 GHz, bands currently allocated to WiGig such as WiGig Band 1 (57.24-59.40 GHz), WiGig Band 2 (59.40-61.56 GHZ) and WiGig Band 3 (61.56-63.72 GHz) and WiGig Band 4 (63.72-65.88 GHZ), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Aspects described herein can also implement a hierarchical application of the scheme is possible, e.g., by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc.

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.].

Some of the features in this document are defined for the network side, such as Access Points, eNodeBs, New Radio (NR) or next generation Node Bs (gNodeB or gNB—note that this term is typically used in the context of 3GPP fifth generation (5G) communication systems), etc. Still, a User Equipment (UE) may take this role as well and act as an Access Points, eNodeBs, gNodeBs, etc. I.e., some or all features defined for network equipment may be implemented by a UE.

### Additional Notes

The following, non-limiting examples, detail certain aspects of the present subject matter to solve the challenges and provide the benefits discussed herein, among others.

Example 1 is a system for controlling an infrastructure item located proximate a crossing, the system comprising: at least one processor; and a memory storing instructions that, when executed by the at least one processor, cause the at least one processor to perform actions comprising: receiving environmental data, the environmental data capturing behavior of a crossing user, determining an intent of the crossing user based on the environmental data, and changing a setting of the infrastructure item based on the intent of the crossing user.

In Example 2, the subject matter of Example 1 optionally includes wherein receiving the environmental data comprises for receiving route data from a mobile device of the crossing user.

In Example 3, the subject matter of any one or more of Examples 1-2 optionally include wherein receiving the environmental data comprises receiving a projected course of the crossing user.

In Example 4, the subject matter of any one or more of Examples 1-3 optionally include wherein receiving the environmental data comprises receiving images of the crossing user from one or more cameras located proximate the crossing.

In Example 5, the subject matter of any one or more of Examples 1˜4 optionally include wherein receiving the environmental data comprises receiving telemetry data from a modality of transportation operated by the crossing user.

In Example 6, the subject matter of any one or more of Examples 1-5 optionally include wherein receiving the environmental data comprises receiving telemetry data from one or more vehicles operating in a roadway proximate the crossing.

In Example 7, the subject matter of any one or more of Examples 1-6 optionally include wherein determining the intent of the crossing user comprises determining a projected course of the crossing user based on the environmental data.

In Example 8, the subject matter of any one or more of Examples 1-7 optionally include wherein the environmental data includes images of the crossing user, and determining the intent of the crossing user comprises determining a projected course of the crossing user using object tracking within the images of the crossing user.

In Example 9, the subject matter of any one or more of Examples 1-8 optionally include wherein changing the setting of the infrastructure item comprises transmitting a command to at least one of a traffic signal and a crosswalk signal.

In Example 10, the subject matter of any one or more of Examples 1-9 optionally include wherein changing the setting of the infrastructure item comprises changing a phase of at least one of a traffic signal and a crosswalk signal.

In Example 11, the subject matter of any one or more of Examples 1-10 optionally include wherein changing the setting of the infrastructure item comprises changing a duration of a lighting phase.

In Example 12, the subject matter of any one or more of Examples 1-11 optionally include wherein the actions further comprise transmitting a message to at least one of a mobile device and a wearable device of the crossing user.

In Example 13, the subject matter of any one or more of Examples 1-12 optionally include wherein the actions further comprise: transmitting a message to one or more vehicles operating proximate the crossing; and receiving an acknowledgement from each of the one or more vehicles in response to receiving the message.

In Example 14, the subject matter of any one or more of Examples 1-13 optionally include wherein the system is a component of the infrastructure item.

In Example 15, the subject matter of any one or more of Examples 1-14 optionally include wherein the infrastructure item is a traffic signal, a crosswalk signal, or a roadside unit.

Example 16 is an infrastructure item located proximate a crossing, the infrastructure item comprising: a traffic light configured to direct a flow of traffic proximate the crossing; at least one processor in electrical communication with the traffic light; and a memory storing instructions that, when executed by the at least one processor, cause the at least one processor to perform actions comprising: receiving environmental data, the environmental data capturing behavior of a crossing user, determining an intent of the crossing user based on the environmental data, and changing the traffic light from a first state to a second state based on the intent of the crossing user.

In Example 17, the subject matter of Example 16 optionally includes wherein the first state comprises a red phase and the second state comprises a green phase.

In Example 18, the subject matter of any one or more of Examples 16-17 optionally include wherein the first state comprises a green phase and the second state comprises a red phase.

In Example 19, the subject matter of any one or more of Examples 16-18 optionally include wherein receiving the environmental data comprises receiving route data from a mobile device of the crossing user.

In Example 20, the subject matter of any one or more of Examples 16-19 optionally include wherein receiving the environmental data comprises receiving a projected course of the crossing user.

In Example 21, the subject matter of any one or more of Examples 16-20 optionally include wherein receiving the environmental data comprises receiving images of the crossing user from one or more cameras located proximate the crossing.

In Example 22, the subject matter of any one or more of Examples 16-21 optionally include wherein receiving the environmental data comprises receiving telemetry data from a modality of transportation operated by the crossing user.

In Example 23, the subject matter of any one or more of Examples 16-22 optionally include wherein receiving the environmental data comprises receiving telemetry data from one or more vehicles operating in a roadway proximate the crossing.

In Example 24, the subject matter of any one or more of Examples 16-23 optionally include wherein determining the intent of the crossing user comprises determining a projected course of the crossing user based on the environmental data.

In Example 25, the subject matter of any one or more of Examples 16-24 optionally include wherein the environmental data includes images of the crossing user, and determining the intent of the crossing user comprises determining a projected course of the crossing user using object tracking within the images of the crossing user.

In Example 26, the subject matter of any one or more of Examples 16-25 optionally include wherein changing the setting of the infrastructure item comprises changing a duration of a lighting phase of the traffic light.

In Example 27, the subject matter of any one or more of Examples 16-26 optionally include wherein the actions further comprise transmitting a message to at least one of a mobile device and a wearable device of the crossing user.

In Example 28, the subject matter of any one or more of Examples 16-27 optionally include wherein the actions further comprise: transmitting a message to one or more vehicles operating proximate the crossing; and receiving an acknowledgement from each of the one or more vehicles in response to receiving the message.

Example 29 is a method for controlling an infrastructure item located proximate a crossing, the method comprising: receiving, at a computing device, environmental data, the environmental data capturing behavior of a crossing user, determining, by the computing device, an intent of the crossing user based on the environmental data, and changing, by the computing device, a setting of the infrastructure item based on the intent of the crossing user.

In Example 30, the subject matter of Example 29 optionally includes wherein receiving the environmental data comprises receiving route data from a mobile device of the crossing user.

In Example 31, the subject matter of any one or more of Examples 29-30 optionally include wherein receiving the environmental data comprises receiving a projected course of the crossing user.

In Example 32, the subject matter of any one or more of Examples 29-31 images of the crossing user from one or more cameras located proximate the crossing.

In Example 33, the subject matter of any one or more of Examples 29-32 optionally include wherein receiving the environmental data comprises receiving telemetry data from a modality of transportation operated by the crossing user.

In Example 34, the subject matter of any one or more of Examples 29-33 optionally include wherein receiving the environmental data comprises receiving telemetry data from one or more vehicles operating in a roadway proximate the crossing.

In Example 35, the subject matter of any one or more of Examples 29-34 optionally include wherein determining the intent of the crossing user comprises determining a projected course of the crossing user based on the environmental data.

In Example 36, the subject matter of any one or more of Examples 29-35 optionally include wherein the environmental data includes images of crossing user, and determining the intent of the crossing user comprises determining a projected course of the crossing user using object tracking within the images of the crossing user.

In Example 37, the subject matter of any one or more of Examples 29-36 optionally include wherein changing the setting of the infrastructure item comprises transmitting a command to at least one of a traffic signal and a crosswalk signal.

In Example 38, the subject matter of any one or more of Examples 29-37 optionally include wherein changing the setting of the infrastructure item comprises changing a phase of at least one of a traffic signal and a crosswalk signal.

In Example 39, the subject matter of any one or more of Examples 29-38 optionally include wherein changing the setting of the infrastructure item comprises changing a duration of a lighting phase.

In Example 40, the subject matter of any one or more of Examples 29-39 optionally include transmitting a message to at least one of a mobile device and a wearable device of the crossing user.

In Example 41, the subject matter of any one or more of Examples 29-40 optionally include transmitting a message to one or more vehicles operating proximate the crossing; and receiving an acknowledgement from each of the one or more vehicles in response to receiving the message.

In Example 42, the subject matter of any one or more of Examples 29-41 optionally include wherein the method is executed by a component of the infrastructure item.

Example 43 is at least one computer-readable medium comprising instructions to perform any of the methods of Examples 29-41.

Example 44 is an apparatus comprising means for performing any of the methods of Examples 29-41.

Example 45 is a method for controlling an infrastructure item located proximate a crossing, the method comprising: receiving, by a computing device, environmental data, the environmental data capturing behavior of a crossing user, determining, by the computing device, an intent of the crossing user based on the environmental data, and changing, by the computing device, a light of the infrastructure from a first state to a second state based on the intent of the crossing user.

In Example 46, the subject matter of Example 45 optionally includes wherein the first state comprises a red phase and the second state comprises a green phase.

In Example 47, the subject matter of any one or more of Examples 45-46 optionally include wherein the first state comprises a green phase and the second state comprises a red phase.

In Example 48, the subject matter of any one or more of Examples 45-47 optionally include wherein receiving the environmental data comprises receiving route data from a mobile device of the crossing user.

In Example 49, the subject matter of any one or more of Examples 45-48 optionally include wherein receiving the environmental data comprises receiving a projected course of the crossing user.

In Example 50, the subject matter of any one or more of Examples 45-49 images of the crossing user from one or more cameras located proximate the crossing.

In Example 51, the subject matter of any one or more of Examples 45-50 optionally include wherein receiving the environmental data comprises receiving telemetry data from a modality of transportation operated by the crossing user.

In Example 52, the subject matter of any one or more of Examples 45-51 optionally include wherein receiving the environmental data comprises receiving telemetry data from one or more vehicles operating in a roadway proximate the crossing.

In Example 53, the subject matter of any one or more of Examples 44-52 optionally include wherein determining the intent of the crossing user comprises determining a projected course of the crossing user based on the environmental data.

In Example 54, the subject matter of any one or more of Examples 45-53 optionally include wherein the environmental data includes images of crossing user, and determining the intent of the crossing user comprises determining a projected course of the crossing user using object tracking within the images of the crossing user.

In Example 55, the subject matter of any one or more of Examples 45-54 optionally include wherein changing the setting of the infrastructure item comprises changing a duration of a lighting phase of the light.

In Example 56, the subject matter of any one or more of Examples 45-55 optionally include transmitting a message to at least one of a mobile device and a wearable device of the crossing user.

In Example 57, the subject matter of any one or more of Examples 45-56 optionally include transmitting a message to one or more vehicles operating proximate the crossing; and receiving an acknowledgement from each of the one or more vehicles in response to receiving the message.

In Example 58, the subject matter of any one or more of Examples 45-57 optionally include wherein the method is executed by a component of the infrastructure item.

Example 59 is at least one computer-readable medium comprising instructions to perform any of the methods of Examples 45-57.

Example 60 is an apparatus comprising means for performing any of the methods of Examples 45-57.

In Example 61, the apparatuses or method of any one or any combination of Examples 1-60 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1.-25. (canceled)

26. A system for controlling an infrastructure item located proximate to a crossing, the system comprising:
at least one processor; and
a memory storing instructions that, when executed by the at least one processor, cause the at least one processor to perform actions comprising:
receiving environmental data, the environmental data capturing behavior of a crossing user,
determining an intent of the crossing user based on the environmental data, and
changing a setting of the infrastructure item based on the intent of the crossing user.

27. The system of claim 26, wherein receiving the environmental data comprises receiving route data from a mobile device of the crossing user.

28. The system of claim 26, wherein receiving the environmental data comprises receiving a projected course of the crossing user.

29. The system of claim 26, wherein receiving the environmental data comprises receiving images of the crossing user from one or more cameras located proximate the crossing.

30. The system of claim 26, wherein receiving the environmental data comprises receiving telemetry data from a modality of transportation operated by the crossing user.

31. The system of claim 26, wherein receiving the environmental data comprises receiving telemetry data from one or more vehicles operating in a roadway proximate the crossing.

32. The system of claim 26, wherein determining the intent of the crossing user comprises determining a projected course of the crossing user based on the environmental data.

33. The system of claim 26, wherein the environmental data includes images of the crossing user, and wherein determining the intent of the crossing user comprises determining a projected course of the crossing user using object tracking within the images of the crossing user.

34. The system of claim 26, wherein changing the setting of the infrastructure item comprises transmitting a command to at least one of a traffic signal and a crosswalk signal.

35. The system of claim 26, wherein changing the setting of the infrastructure item comprises changing a phase of at least one of a traffic signal and a crosswalk signal.

36. The system of claim 26, wherein changing the setting of the infrastructure item comprises changing a duration of a lighting phase.

37. The system of claim 26, wherein the actions further comprise transmitting a message to at least one of a mobile device and a wearable device of the crossing user.

38. The system of claim 26, wherein the actions further comprise:
transmitting a message to one or more vehicles operating proximate the crossing; and
receiving an acknowledgement from each of the one or more vehicles in response to receiving the message.

39. The system of claim 26, wherein the system is a component of the infrastructure item.

40. The system of claim 26, wherein the infrastructure item is a traffic signal, a crosswalk signal, or a roadside unit.

41. An infrastructure item located proximate a crossing, the infrastructure item comprising:
a traffic light configured to direct a flow of traffic proximate the crossing;
at least one processor in electrical communication with the traffic light; and
a memory storing instructions that, when executed by the at least one processor, cause the at least one processor to perform actions comprising:
receiving environmental data, the environmental data capturing behavior of a crossing user,
determining an intent of the crossing user based on the environmental data, and
changing the traffic light from a first state to a second state based on the intent of the crossing user.

42. The infrastructure item of claim 41, wherein the first state comprises a red phase and the second state comprises a green phase.

43. The infrastructure item of claim 41, wherein the first state comprises a green phase and the second state comprises a red phase.

44. The infrastructure item of claim 41, wherein receiving the environmental data comprises receiving images of the crossing user from one or more cameras located proximate the crossing.

45. The infrastructure item of claim 41, wherein the environmental data includes images of the crossing user, and wherein determining the intent of the crossing user comprises determining a projected course of the crossing user using object tracking within the images of the crossing user.
